(19) United States
(12) Patent Application Publication
(10) Pub. No.: US 2009/0219270 A1
(43) Pub. Date: Sep. 3, 2009

(54) APPARATUS FOR DRIVING AN LCD DISPLAY WITH REDUCTED POWER CONSUMPTION

(75) Inventors: Milen Penev, Dietikon (CH); Sergey Kuznetsov, Zurich (CH); Seraphin N. Itoua, Zurich (CH)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/093,694

(22) PCT Filed: Oct. 29, 2006
(86) PCT No.: PCT/IB06/53994

§ 371 Date: Feb. 26, 2009

(30) Foreign Application Priority Data
Nov. 18, 2005 (EP) 05110946.0

(51) Int. Cl. G09G 5/00

(52) U.S. Cl. 345/211

(57) ABSTRACT

Apparatus (200) for driving an LCD display. The apparatus (200) comprises a source driver which is operated between a first power supply rail (VDDH) and a second power supply rail (VSSH). The source driver comprises a power buffer (22) being arranged between the first and the second power supply rails (VDDH, VSSH). The power buffer (22) provides at an output (32) a virtual voltage (VV) of about half the voltage between the two power supply rails (VDDH, VSSH). Furthermore, a P-buffer (20) and an N-buffer (21) are provided. The P-buffer (20) is situated between the first power supply rail (VDDH) and the virtual voltage (VV), and the N-buffer (21) is situated between the virtual voltage (VV) and the second power supply rail (VSSH). The P-buffer (20; 31) is driven at its input side (27) by gamma voltages in an upper voltage regime (VᵢₙₚᵤₜP) and the N-buffer (21) is at its input side (28) driven by gamma voltages in a lower voltage regime.

The driving circuit for an LCD (e.g., an active matrix LCD) can be divided in two parts: a source and a gate driver. The gate driver controls the gates of the transistors to select and deselect the pixels of a specific row. The source drivers provide the required voltage level to all sub-pixels of the currently selected row corresponding to the desired intensity for each color. For this purpose, the source drivers typically comprise analog output buffers.

LCD driver circuits include more and more channels in a single chip, while the output voltage range, and, consequently, the analog supply voltage become larger in order to provide an increased dynamic range and color depth. Due to the high number of channels and the increased supply voltage, one of the most important parameters of a driver circuit, namely the overall power consumption, is mainly determined by the power consumption of the analog output buffers.

Conventional source drivers contain two different types of analog output buffers. In some implementations so-called polarity dependent drivers containing N and P output buffers (herein referred to as N-buffers and P-buffers) are employed. The full supply voltage range of the source driver is supplied to these output buffers, but they work only in the upper or the lower regime of the supply voltage range.

There are also display implementations where so-called rail-to-rail output buffers (herein referred to as P rail-to-rail buffers and N rail-to-rail buffers) are employed. These output buffers are typically positioned between two power supply rails of the supply voltage regime.

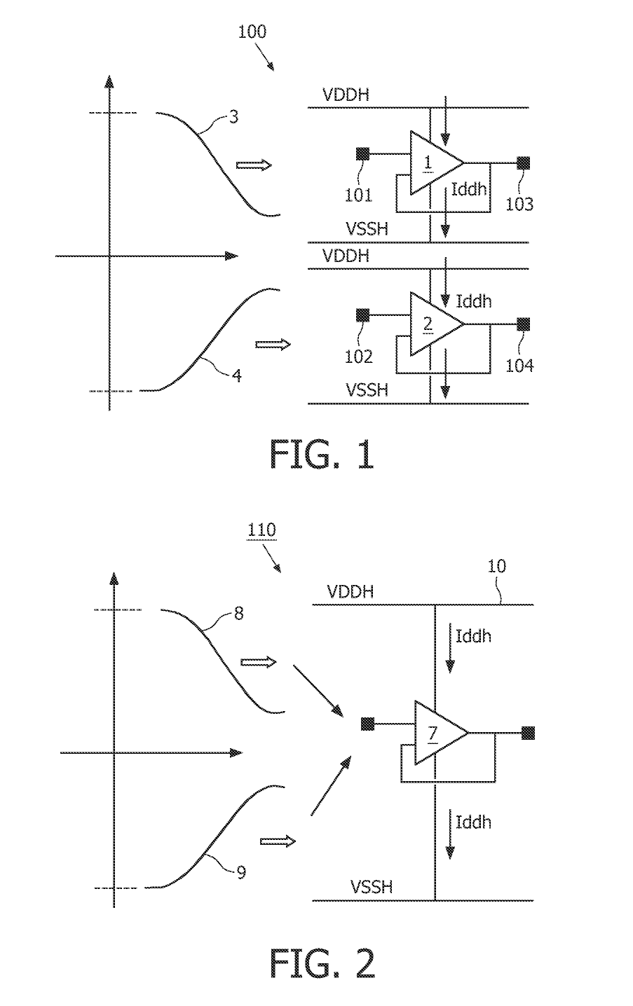

In FIG. 1 an example of a conventional source driver 100 with polarity dependent output buffers 1, 2 is shown. In this example each pixel of the display (i.e., each output 103, 104 of the driver 100) may be driven either by a P output buffer 1 or N output buffer 2, depending on the polarity at the respective inputs 101, 102 of the P output buffer 1 or the N output buffer 2. As indicated in FIG. 1, the positive part of the gamma curve 3 is applied to the input 101 of the P output buffer 1, whereas the negative part of the gamma curve 4 is applied to the input 102 of the N output buffer 2 so that both buffers 1 and 2 are always in use. A consequence of this design is that the supply voltages have to be defined and “hard-wired” during the design of the source driver chip 100 and cannot be altered afterwards. Since the supply of the two output buffers 1, 2 is provided by the two power rails VDDH, VSSH, these buffers 1, 2 must be composed by high voltage transistors. The power is so high in this case because both buffers 1, 2 use the entire supply voltage range between VDDH and VSSH.

Another disadvantage of this design is that due to the fact that high voltage transistors are required, quite some chip area is occupied.

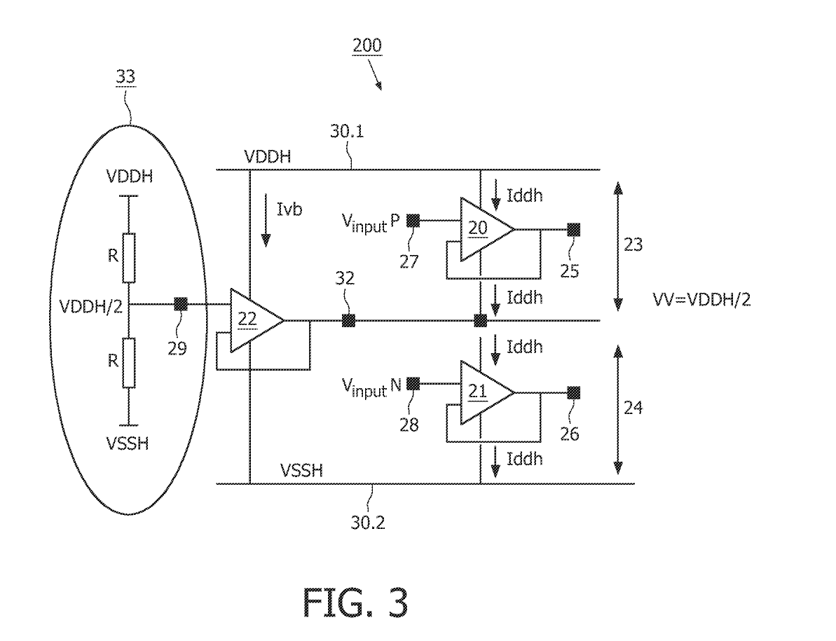

FIG. 2 presents a conventional architecture with rail-to-rail buffers. In FIG. 2 part of a driver chip 110 with one such rail-to-rail buffer 7 is shown. When such a rail-to-rail buffer 7 is used, this single buffer 7 has to drive both positive 8 and negative gamma 9 voltages. The buffer 7, however, still operates in the whole supply voltage range, thus having the same disadvantages of the high voltage transistors, namely increased power consumption and large size.

For both cases presented, the DC power consumption of the output buffers can be calculated as:

TotalPowerPerChannel=VDDH•Iddh_average

where Iddh_average is the average current flowing through the two buffers 1 and 2 in FIG. 2 or through the buffer 7 in FIG. 2.

For the whole driver chip 100 or 110, this value must be multiplied by the number of channels N_{channels}.

TotalPowerPerChip=TotalPowerPerChannel•N_{channels}

The major drawback of both designs is, as mentioned, the high power consumption and the large chip area.

It is thus an object of the present invention to provide a driving scheme for use in a display that consumes less power than conventional display drivers, and that enables the design of smaller driver chips.

This and other objects are accomplished by an apparatus according to claim 1.

According to the present invention an apparatus for driving an LCD display is provided where a new and inventive TFT LCD driving technique is employed. The apparatus comprises a source driver operating between a first and a second power supply rail. The source driver has at least one power buffer arranged between these power supply rails. The power buffer provides at an output a virtual voltage of about half the voltage being available between the two power supply rails. Furthermore, the source driver comprises a large number of P- and N-buffers (depending on number of output channels, typically several hundreds). As P-buffers and N-buffers either rail-to-rail buffers or polarity dependent buffers can be employed. The P-buffer is situated between the first power supply rail and the output where the virtual voltage is made available. The N-buffer is situated between the output where the virtual voltage is made available and the second power supply rail. According to the present invention, the P-buffer is driven by a positive gamma voltage curve and the N-buffer is employed such that it is driven by a negative gamma voltage curve.

According to the present invention, the reduction of the power consumption and area typically occupied by the high voltage transistors is achieved by using a new and inventive TFT LCD driving technique providing for a reduced power consumption.

According to another embodiment of the present invention, a set of switches is employed in order to be able to operate a buffer during a first load cycle between the first power supply rail and a rail where the virtual voltage is made available and during a subsequent load cycle between the virtual voltage rail and the second power supply rail. This embodiment has the advantage that a constant offset is ensured.

Further advantageous embodiments of the apparatus are provided in the dependent claims.

Instead of having DC consumption over the full power supply range, as in case of conventional drivers shown in FIG. 1 and 2, the present invention uses only about half of the supply voltage for each output buffer. A strong power buffer is employed in order to create a virtual voltage acting as a power supply for the N-buffers and as ground for the P-buffers. According to the present invention, this virtual voltage is created internally inside the driver circuit, and is in the most preferred embodiment shared by all channels (i.e., by all N- and P-buffers of an integrated circuit) of the driver circuit.

In another embodiment of the present invention the proposed power reduction technique is used in conjunction with rail-to-rail output buffers.

In yet another embodiment of the present invention the proposed power reduction technique is used in conjunction with polarity-dependent buffers.

The power consumed by the driver circuits in accordance with the present invention is about half of the power consumed by the conventional architecture.

Another advantage of the present invention is the area reduction, due to the fact that low voltage transistors can be used instead of high voltage transistors. This is possible because the highest voltage across the transistors is always about half of the potential difference between the two power supply rails.

Another embodiment of the invention is characterized in that the offset of each channel of the driver circuit is kept constant in the whole working range. Since the polarity of the output voltage changes with every load cycle, a set of switches is employed. As each of the two buffers (N-buffer and P-buffer) only works in their own supply regime, cross selection switches may be employed in this embodiment in order to change polarity.

For a more complete description of the present invention and for further objects and advantages thereof, reference is made to the following description, taken in conjunction with the accompanying drawings, in which:

FIG. 1 is a schematic representation of a conventional display driver using polarity dependent output buffers;

FIG. 2 is a schematic representation of a conventional display driver using a rail-to-rail buffer;

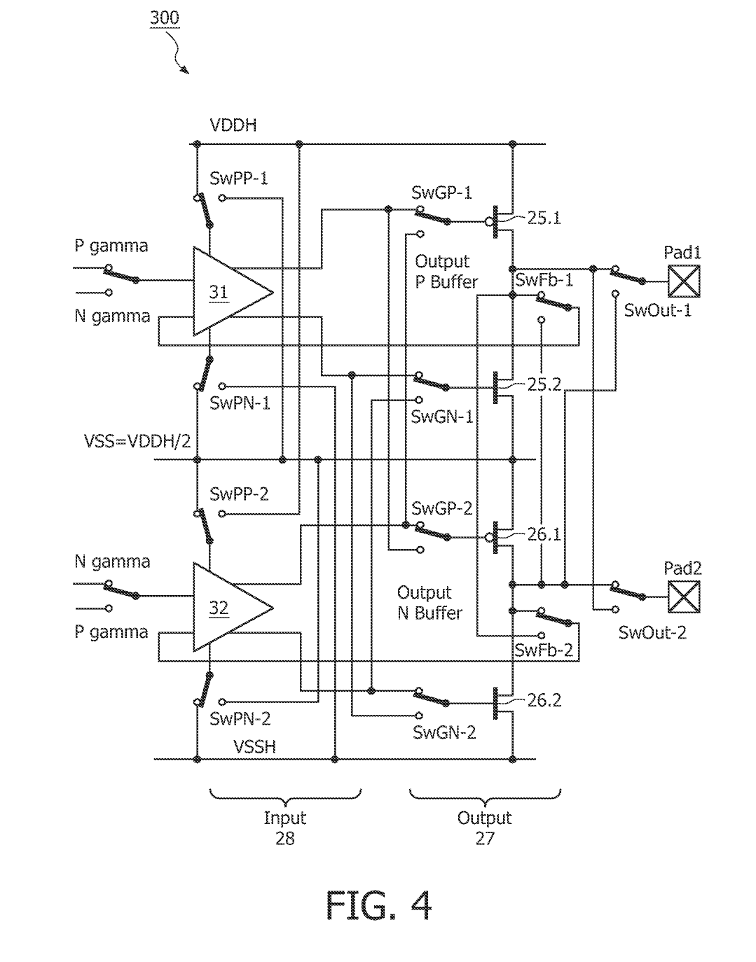

FIG. 3 is a schematic representation of a first embodiment of the present invention using a power buffer and two rail-to-rail buffers;

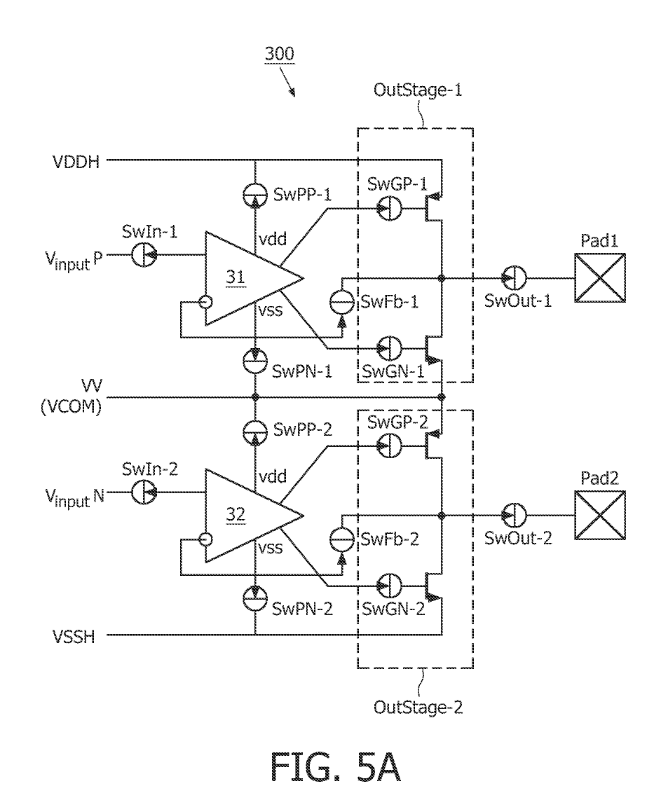

FIG. 4 is a schematic representation of a second embodiment of the present invention;

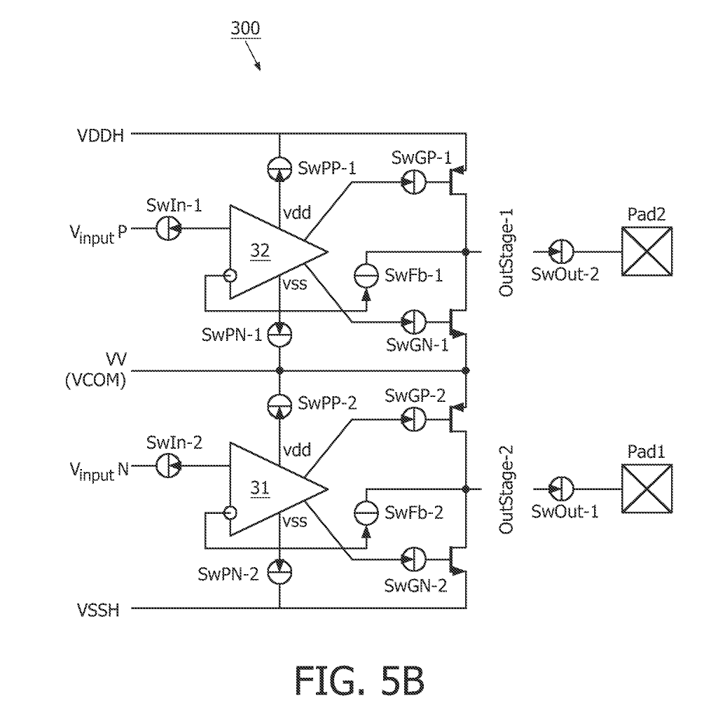

FIG. 5A is another schematic representation of the second embodiment of the present invention during a frame N;

FIG. 5B is another schematic representation of the second embodiment of the present invention during a frame N+1;

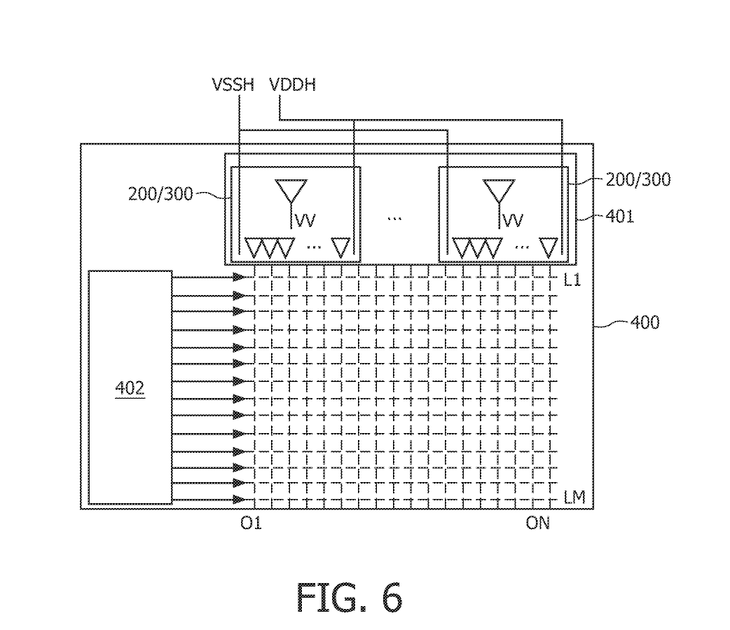

FIG. 6 is another embodiment of the present invention.

A first embodiment of the present invention is presented in FIG. 3, depicting part of a source driver 200 for LCD displays. The apparatus comprises of a power divider 33, a power buffer 22, a P rail-to-rail buffer 20 and an N rail-to-rail buffer 21.

The power divider 33 is made of two resistors R being arranged in series between the power supply rails VDDH 30.1 and VSSH 30.2, having a middle node 29 connected to an input of the power buffer 22.

The power buffer 22 is arranged between the power supply rails VDDH 30.1 and VSSH 30.2, having one of its inputs connected to the middle node 29 of the power divider 33 and connected to an output 32. This kind of arrangement is herein referred to as voltage follower or unity gain configuration. This power buffer 22 provides at its output 32 a virtual voltage VV of about half the voltage that is available between the two power supply rails VDDH and VSSH.

The P rail-to-rail buffer 20 is situated between the first power supply rail VDDH and the virtual voltage VV. This P rail-to-rail buffer 20 is driving positive gamma voltages and shares the Iddh DC current with the N rail-to-rail buffer 21. The respective input signal is herein referred to as VᵢₙₚᵤₜP. That is, the signals VᵢₙₚᵤₜP corresponding to the positive part of the gamma curve is applied to an input 27 of the P rail-to-rail buffer 20.

The N rail-to-rail buffer 21 is being situated between the virtual voltage VV and the second power supply rail VSSH, and is driving negative gamma voltages VᵢₙₚᵤₜN. That is, the signals VᵢₙₚᵤₜN corresponding to the negative part of the gamma curve is applied to an input 28 of the N rail-to-rail buffer 21.

The operating range is divided into two different phases (load cycles or frames), where Frame N is shown on FIG. 3 as 23 and Frame N+1 shown on FIG. 3 as 24. During the first phase (Frame N), the output 25 of the P rail-to-rail buffer 20 drives a column of the display (not shown) and during the second, subsequent phase (Frame N+1) the output 26 of the N rail-to-rail buffer 21 drives the column of the display. That is, while one column is being served by one of the buffers (20 or 21), the respective other buffer (21 or 20) is connected to a neighboring column of the display.

Please note that in FIG. 3 only part of a source driver 200 is shown. A real source driver 200 comprises at least one power buffer 22 and a plurality of pairs of P rail-to-rail buffers 20 and N rail-to-rail buffers 21. The number of pairs of buffers corresponds to the number of channels N_{channels}.

According to FIG. 3 and assuming one can derive the following formula to calculate the total power consumed by the source driver 200:

$$TotalPowerPerChip = \frac{VDDH}{2} \cdot {I}_{ddh} \cdot {N}_{channels} + Ivb \cdot {V}_{DDH} ;$$

where Ivb is the current “consumed” by the power buffer 22 and Iddh the current “consumed” by the buffers 20, 21. From this equation one can derive that the power consumption of the inventive source driver 200 is at about half of the power consumption of a conventional source driver (if one disregards the power consumed by the power buffer 22).

In FIG. 4 another embodiment of an apparatus 300 of the present invention is depicted. As illustrated in this Figure, the P rail-to-rail buffer and the N rail-to-rail buffer each comprise two stages, where the first stage is referred to as input stage 28 and the second stage is referred to as output stage 27. The input stage 28 of the P rail-to-rail buffer comprises an input buffer 31 and the input stage 28 of the N rail-to-rail buffer comprises an input buffer 32. The output stage 27 of the P rail-to-rail buffer comprises two power transistors 25.1, 25.2 serving as P output buffer, and the output stage 27 of the N rail-to-rail buffer comprises two power transistors 26.1, 26.2 serving as N output buffer. Each of the input buffers 31 or 32 can be connected to either output stage 27 or 28, thus arranging a voltage-follower (or unity gain configuration).

A set of switches SwPP-1, SwPN-1, SwGP-1, SwGN-1, SwFb-1, SwOut-1 and SwPP-2, SwPN-2, SwGP-2, SwGN-2, SwFb-2, SwOut-2 is provided in order to be able to change the polarity of the output signals at the output pads Pad1 and Pad2. These switches are controlled so that during a first frame (Frame N) the input VᵢₙₚᵤₜP, i.e., the positive part of the gamma curve (P gamma), is “connected” via the input buffer 31 and the output stage with transistors 25.1, 25.2 to the Pad1 and a respective first display channel. During the subsequent second frame (Frame N+1), the input VᵢₙₚᵤₜN, i.e., the negative part of the gamma curve (N gamma), is “connected” via the input buffer 31 and the output stage with transistors 25.1, 25.2 to the Pad1. During the first frame (Frame N), the input buffer 31 operates between the voltages VDDH and VV whereas during the second frame (Frame N+1) the input buffer 31 operates between the voltages VV and VSSH. During the first frame (Frame N) the input VᵢₙₚᵤₜN, i.e., the negative part of the gamma curve (N gamma), is “connected” via the input buffer 32 and the output stage with transistors 26.1, 26.2 to the Pad2 (and a respective second display channel) and during the subsequent second frame (Frame N+1), the input VᵢₙₚᵤₜP, i.e., the positive part of the gamma curve (P gamma), is connected via the input buffer 32 and the output stage with transistors 26.1, 26.2 to the Pad2. During the first frame (Frame N), the input buffer 32 operates between the voltages VV and VSSH whereas during the second frame (Frame N+1) the input buffer 32 operates between the voltages VDDH and vv.

The embodiment depicted in FIG. 4 has the advantage that the offset of each channel is kept constant in the whole working range, since the same input buffers 31, 32 are used to drive one and the same output pad with the positive and negative parts of the gamma curve. Since the polarity of the output voltages changes with each frame (load cycle) a set of switches, as illustrated in FIG. 4, must be used. Since each of the buffers 31, 32 can only work in its own supply regime, the output signals have to be changed using cross-selection switches, as shown. In order to keep the offset of each channel constant over the whole range of the gamma curve, additional switches SwPP-1, SwPN-1, and SwPP-2, SwPN-2 are used to commutate the supply lines for both input buffers 31, 32.

It is sufficient to just commutate the input buffers of the apparatus 300 since the offset is caused by the input buffers 31, 32 mainly. This means that it is not necessary to commutate the elements of the output stages 27. The output stages 27 can be strongly connected to the supply lines VDDH, VV and VV, VSSH, respectively. This approach allows to saves chip area since for the commutation of the output stages 27 strong and large switches would be required.

In order to better illustrate this embodiment, additional details are described in connection with the FIGS. 5A and 5B. In FIG. 5A, part of a inventive apparatus 300 are shown during a first frame (Frame N). FIG. 5B shows the same apparatus 300 during a second frame (Frame N+1). The FIGS. 5A and 5B are drawn such that the commutation of the supply regimes becomes visible.

The apparatus 300 comprises two input buffer 31, 32. The input buffers 31, 32 are two identical operational amplifiers (without output stage), which, when connected to an output stage, create a voltage follower (or unity-gain) configuration. Each of them is capable of handling the input and output voltages in the whole range between two supply rails. This feature is referred to as Rail-to-Rail operation. The amplifiers are implemented in such a way that they may be supplied between any two supply rails that exist inside the apparatus 300 (e.g. inside the source driver). This feature is referred to as floating amplifiers.

The apparatus 300 further comprises two high-voltage output stages (Outstage-1 and Outstage-2). These two high-voltage output stages are firmly connected between the corresponding supply rails. That is, the OutStage-1 is connected between VDDH and VV whereas the OutStage-2 is connected between VV and VSSH.

There is a set of paired switches that allows exchanging the signals from the wires marked with arrows. For example, the switches SwPP-1 and SwPP-2 together serve as a paired switch. In one position, as shown for a Frame N in FIG. 5A, they provide a connection between the terminal vdd of the buffer 31 and the upper power supply VDDH, and, respectively, terminal vdd of the buffer 32 and the virtual power supply VV. In another position, depicted for the Frame N+1 in FIG. 5B, these switches SwPP-1 and SwPP-2 provide a connection of the terminal vdd of the buffer 31 to the virtual power supply VV, and, respectively, between the terminal vdd of the buffer 32 and the upper power supply VDDH.

The paired switches SwPP-1 and SwPP-2 and the paired switches SwPN-1 and SwPN-2 are used to connect each buffer 31, 32 between either supply rails VDDH and VV or VV and VSSH.

The virtual voltage VV is provided by a power buffer, as in case of FIG. 3, for instance.

The paired switches SwIn-1 and SwIn-2 at the input side of the input buffers 31, 32 are used to connect the inputs of either buffer 31, 32 to either signal source VᵢₙₚᵤₜP (positive part of the gamma curve) or VᵢₙₚᵤₜN (negative part of the gamma curve).

The paired switches SwGP-1 and SwGP-2 and the paired switches SwGN-1 and SwGN-2 are used to connect the gates of the transistors 25.1, 25.2, 26.1, 26.2 of the output stages OutStage-1 and OutStage-2 to the controlling signals of either buffer 31, 32.

The paired switches SwOut-1 and SwOut-2 are used to redirect the output signal of the OutStage-1 and OutStage-2 to either output pad Pad1 or Pad2.

The paired switches SwFb-1 and SwFb-2 are used to provide feedback input for each buffer 31, 32 from the output of the appropriate output stage OutStage-1 or OutStage-2.

Using a set of paired switches as illustrated in FIGS. 4 and 5A, 5B, the offset of each channel is kept constant during the positive part of the gamma curve and the negative part of the gamma curve, since the same input buffer is used for both parts of the gamma curve. In general, the toggling all the paired switches is equivalent to exchanging the two buffers (placing buffer 31 instead of buffer 32 and vice-versa), and exchanging the two output pads Pad1 and Pad2.

In FIG. 6 an apparatus 400 is shown which comprises a gate driver 402 and a source driver 401 for driving the pixels of a display panel. The display panel is schematically shown by a grid comprising M rows and N columns. The invention is implemented inside the source driver 401. In the present embodiment of the invention, the source driver 401 comprises a plurality of integrated circuits 200/300. The source driver 401 is supplied be an upper voltage VDDH and a lower voltage VHHS. Each of the integrated circuits 200/300 comprises one power buffer. These power buffers provide a virtual voltage which is about half the voltage between the two power supply rails VDDH and VSSH. In FIG. 6, the power buffers and the virtual voltage VV are schematically depicted. A the output side of each integrated circuit 200/300 there is a number of P-buffers and N-buffers for driving the channels of the display. In FIG. 6, the P-buffers and N-buffers are schematically depicted as a row of triangles.

The P-buffers of the integrated circuit 200/300 are situated between the upper power supply rail VDDH and the virtual voltage VV and the N-buffers are situated between the virtual voltage VV and the lower power supply rail VSSH. If switches are provided, as in FIGS. 4, 5A and 5B, the supply of the buffers can be commutated.

According to the present invention, embodiments are possible where several intermediate virtual voltages VV1 through VVn are provided (with n=2, 3 . . . ) by a corresponding number of power buffers.

1. Apparatus for driving an LCD display, said apparatus comprising a source driver being operated between a first power supply rail and a second power supply rail, said source driver comprising:
a power buffer being arranged between said first and second power supply rails, said power buffer providing at an output a virtual voltage of about half the voltage between said two power supply rails,
a P-buffer and an N-buffer, said P-buffer being situated between the first power supply rail and the virtual voltage, said N-buffer being situated between the virtual voltage and the second power supply rail, and wherein said P-buffer is at its input side driven by gamma voltages in an upper voltage regime between the first power supply rail and the virtual voltage, and wherein said N-buffer is at its input side driven by gamma voltages in a lower voltage regime between the virtual voltage and the second power supply rail.

2. The apparatus of claim 1, wherein only about half of the total supply voltage between said first power supply rail and said second power supply rail is used as supply voltage of said P-buffer and N-buffer.

3. The apparatus of claim 1, wherein said power buffer provides said virtual voltage serving as virtual ground for said P-buffer R and as a power supply for said N-buffer.

4. The apparatus of claim l, wherein said P-buffer is a P rail-to-rail buffer and said N-buffer is an N rail-to-rail buffer.

5. The apparatus of claim 1, wherein said P-buffer and said N-buffer are polarity-dependent buffers.

6. The apparatus of claim 1, further comprising a power divider with two resistors, said resistors being arranged in series between said two power supply rails, the power divider having a middle node connected to an input of said power buffer.

7. The apparatus of claim 1, further comprising a voltage reference connected to an input of said power buffer.

8. The apparatus of claim 1, wherein said P-buffer and N-buffer are analog buffers.

9. The apparatus of claim 1, wherein the source driver comprises several integrated circuits, each of said integrated circuits comprising one power buffer and a plurality of pairs of P-buffers and N buffers, wherein said power buffer provides the virtual voltage for the plurality of pairs of P-buffers and N-buffers.

10. The apparatus of claim 9, wherein each of said integrated circuits drives a plurality of channels of said display.

11. The apparatus of claim 1, wherein the polarity of output signals provided at the output sides of the P-buffers and N buffers changes with each load cycle.

12. The apparatus of claim 11, further comprising cross-selection switches in order to change the polarity of said output signals.

13. The apparatus of claim 11, further comprising a set of switches in order to commutate the supply of the P-buffers and N-buffers such that
the P-buffer is during a first load cycle supplied by a voltage being available between said first power supply rail and the virtual voltage, and during a subsequent load cycle supplied by a voltage being available between the virtual voltage and said second power supply rail, and
the N-buffer is during the first load cycle supplied by a voltage being available between the virtual voltage and said second power supply rail, and during a subsequent load cycle supplied by a voltage being available between said first power supply rail and the virtual voltage.

14. The apparatus of claim 1, wherein each of the P-buffers and each of the N-buffers comprises an input stage and an output stage.

15. The apparatus claim 14, wherein the respective output stages (OutStage-1, OutStage-2) are connected to column lines of said display and wherein said apparatus comprises a set of switches in order to commutate the supply of the input stages of the P-buffers and N-buffers.
